(19) United States
(12) Patent Application Publication
(10) Pub. No.: US 2002/0152086 A1
(43) Pub. Date: Oct. 17, 2002

(54) Method and apparatus for controlling a lifecycle of an electronic contract

(76) Inventors: Ned M. Smith, Beaverton, OR (US); Eric Dittert, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/784,879

(22) Filed: Feb. 15, 2001

(51) Int. Cl. G06F 17/60; H04K 1/00; H04L 9/00

(52) U.S. Cl. 705/1; 380/30; 382/124; 705/80

(57) ABSTRACT

Managing the lifecycle of an electronic contract representing a relationship between at least two parties sharing a business process includes exchanging public keys for each of the parties, negotiating the electronic contract, digitally signing and verifying the electronic contract, issuing role certificates to participants of the shared business process, the role certificates defining authorization of participants to perform at least a part of the shared business process and for using the public keys, registering, by the participants, to receive the electronic contract, distributing the electronic contract to the participants, and performing the shared business process by the participants. Updating the shared business process may be accomplished by modifying the electronic contract and redistributing the electronic contract to the participants. Terminating the electronic contract may be accomplished by modifying the electronic contract to halt authorization of the shared business process and redistributing the electronic contract to the parties.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field

The present invention relates generally to security of business processes in computer systems and networks and, more specifically, to using electronic contracts to support business processes.

2. Description

Large scale computer networks such as the Internet and the World Wide Web (WWW) have made it possible for companies to automate certain aspects of their businesses where previously it was not possible or cost effective to do so. Recently developed technologies relating to the Internet have been used to replace earlier forms of communication for doing business (e.g., telephone, fax, mail, and personal meetings). These traditional methods of doing business have historically been supported by norms of behavior and laws that are well understood by the business and legal communities. However, when business entities agree to transact business over the Internet, some of the traditional mechanisms for identifying and enforcing business relationships are replaced by electronic, automated mechanisms. Generally, automation can remove physical barriers that help limit exposure to fraud. When one conducts business with another in person, some societal norms, as well as legal constructs, may be used to help ensure that a transaction is authorized and enforceable. When a transaction is done over the Internet between two parties (who may not know each other, or know anything about each other), the possibility of fraud may increase. At a minimum, the parties may be unsure of their rights and duties with respect to the electronic transaction.

Electronic business practices are sometimes referred to as business processes. Business processes may refer to any combination of manual and automated activities that implement the goals of a commercial entity such as a company. Processes that don't involve external entities are called internal processes. Those processes that are externally focused, involving at least some interaction with other entities, are called shared processes. When shared processes are implemented between two entities over a computer network such as the Internet, the potential for dangers such as fraud, repudiation, and unauthorized accesses exists.

Technologies such as firewalls, Secure Sockets Layer (SSL), and Virtual Private Networking (VPN), may be used to help protect such shared processes. However, they are flawed in that they lack mechanisms that tie an expression of the business relationship between the entities (as may be defined by terms and conditions of a legal contract), with security enforcement mechanisms. Furthermore, connection oriented mechanisms (e.g., firewalls, SSL, VPN) are not capable of controlling business interactions at a level of granularity wherein risks of fraud may be significantly reduced. Many of the security mechanisms employed for electronic business rely on certificate authorities (CAs) to hold private cryptographic keys that are not under the control of either party in a business transaction. Use of external CAs results in the disassociation of the terms and conditions of a business agreement with the security mechanisms used to enforce the terms and conditions. This disconnect results in opportunities for fraud to occur.

Furthermore, applying security at lower layers in the network increases the degree of trust a user must have in the computing system used for electronic business practices. A better approach is needed whereby parties to a shared process are better able to articulate the limits, explicitly or implicitly contained in a business contract, to the computing system. Additionally, methods for managing the lifecycle of electronic contracts are needed.

### BRIEF DESCRIPTION OF THE DRAWINGS

The features and advantages of the present invention will become apparent from the following detailed description of the present invention in which:

FIG. 1 is a diagram of shared business processes according to an embodiment of the present invention;

FIG. 2 is a diagram illustrating an electronic contract according to an embodiment of the present invention;

FIG. 3 is a flow diagram of identification and authorization processing using an electronic contract according to an embodiment of the present invention;

FIG. 4 is a diagram of interactions between participants using an electronic contract according to an embodiment of the present invention;

FIG. 5 is a flow diagram illustrating electronic contract lifecycle processing according to an embodiment of the present invention;

FIG. 6 is a flow diagram illustrating the signing and verifying process for an electronic contract according to an embodiment of the present invention; and

FIG. 7 is a diagram illustrating a sample system for implementing and using an electronic contract according to an embodiment of the present invention.

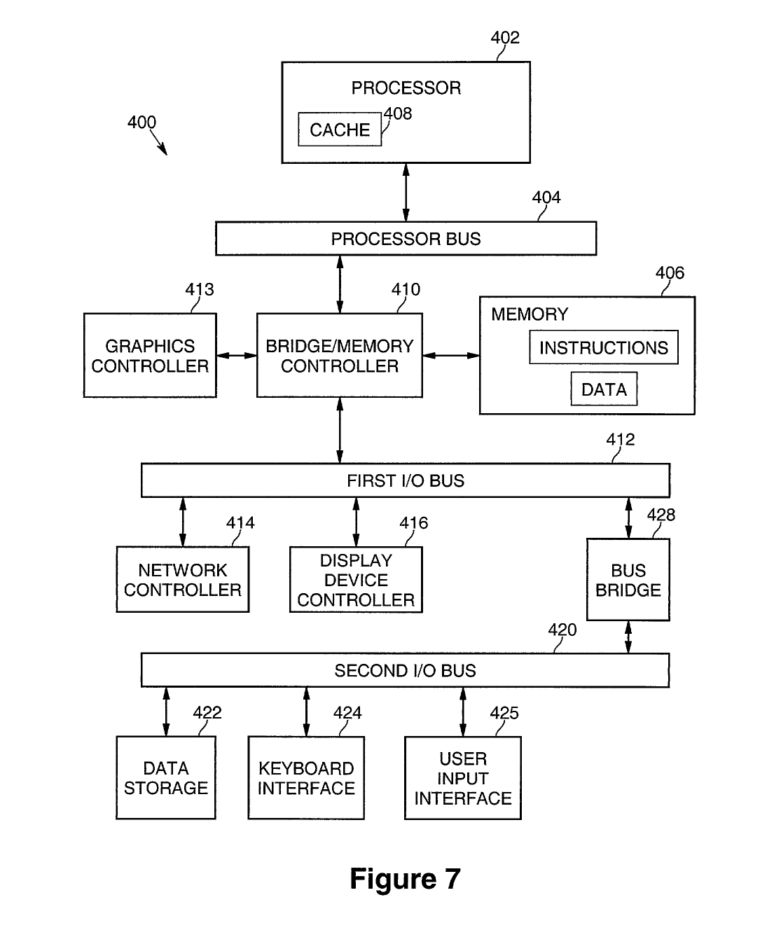

### DETAILED DESCRIPTION

Embodiments of the present invention comprise methods of using a data structure called an electronic contract. The electronic contract may be used to enable the automation of business to business (B2B) electronic commerce (e-commerce) without sacrificing end-to-end security. Electronic contracts may be broadly applied to any electronic relationship based on public key cryptography, where use of keys helps identify actions associated with a business relationship and where the physical world relationship is also governed by contract law. Embodiments of the present invention provide a mechanism for binding public keys of legal entities (e.g., people, companies, etc.) with shared sub-processes of business processes, thereby tying process decisions to public keys which are in turn tied to (non-electronic) business contracts. Thus, embodiments of the present invention support shared processes without the use of trusted third parties (like certificate authorities) and help to deter potential for fraud in such processes.

Embodiments of the present invention also describe a method and apparatus for managing the lifecycle of an electronic contract. The invention defines a process for creating and modifying a shared business process. It identifies parties as participants wherein each party is a shared contributor or agent, with no dominant authority or hierarchy among the parties. The invention creates an environment where each party may cross-check each other during operations of the shared process. The electronic contract associates roles with process elements, thereby mapping items in a template within the electronic contract to actual resources of the parties for performing operations of the shared process. The present approach to electronic contract lifecycle management uses event-driven mechanisms to induce state changes in the lifecycle. This approach prevents unnecessary polling on state variables to detect the need for lifecycle changes. This conserves communication bandwidth and processing resources. Embodiments of the present invention operate in a symmetric, distributed fashion while preserving the trust semantics that are captured in physical world contracts, without involving trusted third parties.

In the physical world, contractual relationships are started, evolve, and are terminated. Similarly, in electronic representations of physical world relationships, a process for creating, updating and disposing of electronic contracts is needed. A lifecycle and associated system may be defined for the electronic contract. The lifecycle defines the steps involved in creating, managing and retiring an electronic contract. In one embodiment, a publish and subscribe apparatus may be used to implement the lifecycle methods. Use of a publish and subscribe model facilitates movement of electronic contract documents as well as drives execution of the lifecycle itself.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

When trading entities wish to share business processes, they typically rely on some form of cryptography to provide security to business message exchanges. The exchanges are meaningful if the sender can be authenticated by the receiver, as one having authority, under the terms and conditions of a contract, to exchange the message. Machine-readable representations of terms and conditions correspond to data structures (such as process definitions, role names, cryptographic keys, etc . . . ). A common representation of shared process elements is needed to avoid syntactic disagreement. Semantic disagreement may also exist. The business contract is the final point of recourse in determining semantics. Interim steps can be taken between parties to specify syntax and semantics electronically and to find a mapping suitable to both/all parties. Embodiments of the present invention provide such a common representation in an electronic form via the electronic contract. The present invention ties public keys of the parties to business process communications exchanges.

One current approach for negotiating a business relationship between two or more parties includes using a trading partner agreement. The trading partner agreement approach typically does not associate a public key with the trading activity, where the authority for that key is also used to protect messages exchanged between the parties. The trading partner agreement approach may require public keys associated with trading partners use a trusted third party (e.g., a CA), which does not share liability for the shared process or does not associate the use of trading partner keys with business contracts. In contrast, the present invention instead uses cross-signing of certain portions of an electronic contract between trading partners (2 or more), thereby providing electronic evidence of the joint intentions of the trading partners to share business processes. The digital signature over the electronic contract allows at least several assertions to be made. The public keys contained in the electronic contract represent a group of business (or legal) entities or parties cooperating together. The parties cooperate through transactions according to the processes, procedures, and conventions described by the electronic contract. Each party (legal entity) identified in the electronic contract agrees to and will be bound by the contract. Each party will assume legal liability and obligations as defined by the contract.

Under previous approaches, if a third party such as a CA cannot be found that both parties trust, then the two parties must rely on less secure or less automated means to engage in business. If a trusted third party is found, it is often the case that the third party disclaims liability for undesirable occurrences happening during the transactions. Hence, there is a need for the original parties to work out the details of their obligations independently. The present invention provides a method for allowing the parties to define the anticipated communication exchanges that may occur during a shared process and mechanisms for automatic verification of terms and conditions of the business relationship.

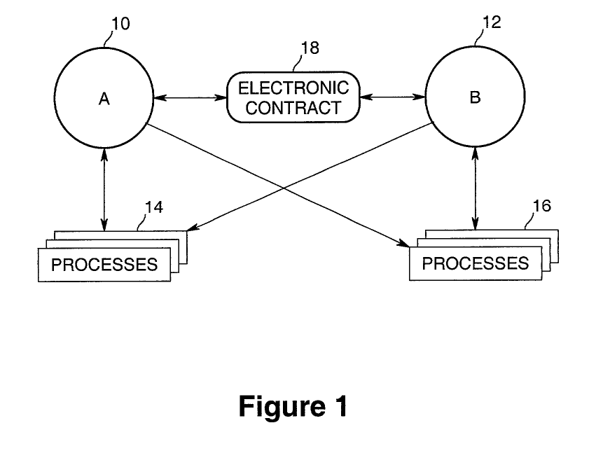

FIG. 1 is a diagram of shared business processes according to an embodiment of the present invention. Parties A 10 and B 12 desire to conduct electronic business together. Although only two parties are shown in this example, it should be understood that any number of parties may communicate using a single electronic contract as defined in the present invention. Party A has a set of one or more electronic business processes 14 that it desires to share with party B. Similarly, party B has a set of one or more electronic business processes 16 that it desires to share with party A. The present invention uses an electronic contract 18 to set up a relationship between A and B such that A trusts B and the results of B's processes, and B trusts A and the results of A's processes. The signed electronic contract 18 comprises a stand-alone document (in XML in one embodiment) that contains both human readable and machine readable representations of a business contract, as well as cryptographic keys that can be used for verification of message exchanges between the trading partners (A and B) or their delegates.

For example, B might have a process to produce some result for B or B's subordinates. Because of the existence of the electronic contract 18, A and A's subordinates can trust the result of B's process. In a reciprocal manner, A might have a process to produce some result for A or A's subordinates. B and B's subordinates can then trust the result of A's process. In this way, A and B may share processes in a trustworthy manner because the electronic contract acts as an interoperability agreement defining the rights, responsibilities, and communications requirements of both A and B. In embodiments of the present invention, the electronic contract includes the public key of an asymmetric cryptographic key pair for each of A and B. The relationship of trust may be asserted because keys respectively controlled by trading partners are part of the electronic contract describing trading partner operational semantics. Operations performed by A, limited by the terms and conditions contained in the electronic contract, can be interpreted by B with the expectation that B's interpretation matches that of A.

Embodiments of the present invention provide at least the following features. The present invention creates an electronic document (e.g., the electronic contract 18) that contains information necessary to allow specific legal entities (e.g., party A 10 and party B 12) to engage in automated exchanges for a specific shared process under protection of a legal contract. It associates cryptographic keys with legal entities. It also associates the cryptographic keys with identifiers representing sub-processes of the shared process, where the shared process may be represented by a descriptive language. In one embodiment, the descriptive language is XML, although other languages may also be used and the invention is not limited in scope in this respect. The process definition for the shared process has the property that the semantics of contractual obligations of the business relationship of the parties are integral to the process definition. The present invention thus associates a human readable contract with a machine readable, electronic contract (the process definition) such that dispute resolution can be arbitrated with human intervention. The electronic contract explicitly declares services jointly agreed to by the parties for the shared process such as auditing, time-stamping, and saving of archives. The electronic contract also explicitly declares information that may be used to qualify the semantics of security related decisions affecting the shared process, such as definition of name spaces and role mappings. Additionally, the present invention uses multiple digital signatures to bind associated information. The semantics of the signatures are such that by signing the electronic contract, the parties jointly agree to the terms and conditions of the electronic contract.

An electronic contract may be applied generally to any relationship where there is an electronic representation and where the physical work relationship is governed by contract law. One mathematical foundation for the electronic contract of the present invention is derived from research disclosed in “SPKI Certificate Theory”, by Carl M. Ellison, Bill Frantz, Butler Lampson, Ron Rivest, Brian M. Thomas, and Tatu Ylonen, Internet RFC 2693, September, 1999, and “An Access-Control Calculus for Spanning Administrative Domains”, by Jon Howell and David Kotz, Technical Report PCS-TR99-361, Department of Computer Science, Dartmouth College, 1999.

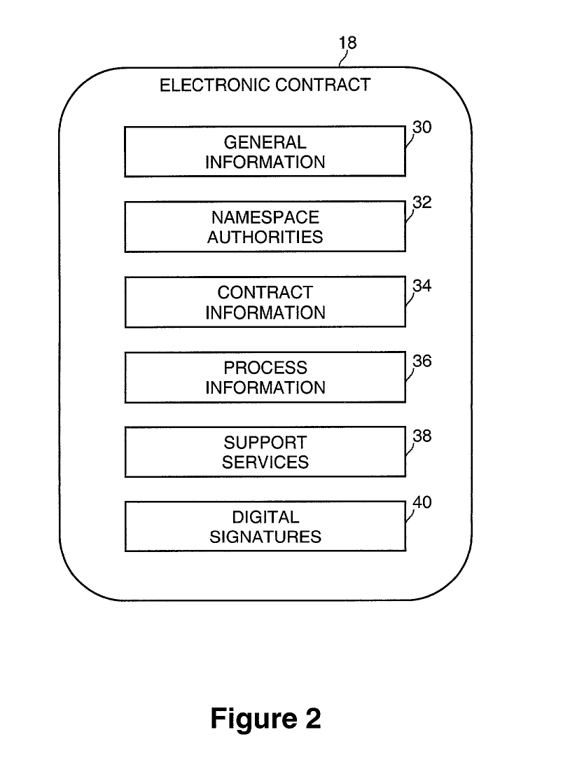

FIG. 2 is a diagram illustrating an electronic contract according to one embodiment of the present invention. Other versions and formats of an electronic contract may also be used in the present electronic contract lifecycle management invention and the invention is not limited in scope by the particular version of electronic contract used. In one example, the electronic contract 18, also called an interoperability agreement, defines an arrangement that associates trading partners with keys, contract and business process elements (sub-processes), from which security mechanisms may base access control decisions. The electronic contract comprises at least the following sections. In one embodiment, general information section 30 provides information specifying an agreement name and identifier, and a current revision level and history data. Namespace authorities section 32 describes third parties representing a namespace corresponding to the domain of the cryptographic keys used in the electronic contract. In some cases, part or all of the shared processes may be defined by standards or other groups external to the trading partner relationship. Namespaces allow a public key to be associated with a reference to the defining entity. Operationally, intricate details of the process definition would not be included in the electronic contract, but referenced externally. Namespaces define the set of external references accepted by trading partners. Contract information section 34 provides data about the underlying business agreement that is the subject of the electronic contract. It associates parties who may be liable under the contract with public keys. This section may include data such as contract identifier, validity period, creation date, arbiter, liable party, signing public keys, and contact information for the parties (e.g., name, address, telephone and fax numbers, etc.).

Process information section 36 provides a mapping of role names for sub-processes of the shared business process, and a specification of the syntax and semantics of role names. In order to share processes, the parties need to have common definitions for business process sub-processes. For example, party A may support purchase order processing but use a term such as “P.O. agent” for A's subordinate who performs this function. Party B, however, might use the term “purchaser” for the same function at B performed by B's subordinates. Thus, the parties may have different names for the same function. This section reconciles the disparate role names for the business process sub-processes. To further illustrate the example, when performing access control evaluation, if one of A's processes related to purchasing were being requested, then a “P.O. agent” would be specified, but if the process is shared between A and B and the term “purchaser” is used by B, this would fail an authorization check but for the mapping of “purchaser” in B to “P.O. agent” in A in the electronic contract.

Support services section 38 describes ancillary services that may be used in support of the shared process. Such services may comprise saving archives, performing audits, and timestamping the agreement. Although three services are described herein, other support services may also be specified. For archives, the section describes the location of where the archive is stored, and the cryptographic keys used to secure the archival data. For audits, the section describes the location of where the audit data is stored, and the cryptographic keys used to secure the audit data. For timestamps, the section describes the location of where the timestamp data is stored, and the cryptographic keys used to secure the timestamp data. In various embodiments, third parties may be employed to provide the archive, audit, and timestamp support services. If the service is outsourced to a third party, the section should specify the public key of the third party so parties A and B agree on the selected third party providing the service. This associates a public key of the third party with the service provided.

Digital signatures section 40 allows trading partners to digitally sign the electronic contract. Each party signs the contract, allowing both multi-lateral and independent verification. This section may comprise digital signatures of the parties as well as digital signatures of one or more witnesses (e.g., third parties). The digital signatures may be pre-pended or appended to the electronic contract.

Table I shows one example of an electronic contract in XML, although other descriptive languages may be used.

TABLE I
<!-- ***************************************************************-->
<!ELEMENT SignedIA (IAData, IASignature)>
<!ELEMENT IAData data %IA;>
<!ELEMENT IASignature %dsig:Signature;>
<!-- ***************************************************************-->
<!-- ***************************************************************-->
<!-- INTEL eContract DTD -->
<!-- File name: IA.DTD-->
<!-- (C) Copyright INTEL Corporation 2000-->
<!-- ***************************************************************-->
<!DOCTYPE eContract[
<!ELEMENT eContract (ECInfo, NameSpace*, ContractInfo, ProcessInfo,
ServiceInfo, Comment*)>
<!ATTLIST IA xmlns CDATA #IMPLIED>
<!-- ***************************************************************-->
<!-- General information -->
<!-- ***************************************************************-->
<!ELEMENT ECInfo (AgeementId, AgreementName, Revision?)>
<!ELEMENT AgreementId (#PCDATA)>
<!ELEMENT AgreementName (#PCDATA)>
<!ELEMENT Revision (History*)>
<!ATTLIST Revision rev CDATA #IMPLIED>
<!ELEMENT History EMPTY>
<!ATTLIST History AgreementId CDATA #REQUIRED>
<!-- ***************************************************************-->
<!-- Namespace Authorities -->
<!-- ***************************************************************-->
<!ELEMENT NameSpace (Id, Location, PublicKey?)>
<!ELEMENT Id (#PCDATA)>
<!ELEMENT PublicKey (#PCDATA)>
<!-- ***************************************************************-->
<!-- Contract Info -->
<!-- ***************************************************************-->
<IELEMENT ContractInfo (

ContractId,
Contract,
ValidityPeriod,
CreationDate,
Arbitor*,
LiableParly+)>

<!ELEMENT ContractId (#PCDATA)>
<!ELEMENT Contract (#PCDATA)>
<!ELEMENT ValidityPeriod EMPTY>
<!ATTLIST ValidityPeriod from CDATA #IMPLIED to CDATA #IMPLIED>
<!ELEMENT CreationDate (#PCDATA)>
<!ELEMENT Arbitor (ContactName, SigningPublicKey)>
<!ELEMENT LiableParty (ContactName, SigningPublicKey)>
<!ELEMENT SigningPublicKey (#PCDATA)>
<!ATTLIST SigningPublicKey KeyId CDATA #REQUIRED><!-- fingerprint -->
<!ELEMENT ContactName (#PCDATA)>
<!-- ***************************************************************-->
<!-- Process Information -->
<!-- ***************************************************************-->
<!ELEMENT ProcessInfo (ProcessDef, PerformerRoleMapping*)>
<!ELEMENT ProcessDef (#PCDATA)>
<!ATTLIST ProcessDef Type NMTOKEN #IMPLIED Ref IDREF #IMPLIED>
<!ELEMENT PerformerRoleMapping (FromRole, ToRole)>
<!ELEMENT FromRole EMPTY>
<!ATTLIST FromRole domainId CDATA #REQUIRED role NMTOKEN
#REQUIRED>
<!-- domainId is the ‘KeyId’ fingerprint for liable party -->
<!ELEMENT ToRole EMPTY>
<!ATTLIST ToRole domainId CDATA #REQUIRED role NMTOKEN #REQUIRED
>
<!-- ***************************************************************-->
<!-- Support Services -->
<!-- ***************************************************************-->
<!ELEMENT ServiceInfo (Archive*, Audit*, Timestamp*)>
<!ELEMENT Archive (Location, SignaturePublicKey, PrivacyPublicKey)>
<!ELEMENT SignaturePublicKey (#PCDATA)>
<!ELEMENT PrivacyPublicKey (#PCDATA)>
<!ELEMENT Audit (Location, SignaturePublicKey, PrivacyPublicKey)>
<!ELEMENT Timestamp (Location, SignaturePublicKey, PrivacyPublicKey)>
<!ELEMENT Location EMPTY>
<!ATTLIST Location Ref CDATA #REQUIRED>
<!-- ***************************************************************-->
<!-- Comment -->
<!-- ***************************************************************-->
<!ELEMENT Comment (#PCDATA)>
]><!-- end of DOCTYPE InteropAgreement -->

Table II illustrates an example XML document complying with the above document type description.

TABLE II
<InteropAgreement>

<IAInfo>

<AgeementId>777777</AgreementId>
<AgreementName>Smith JonesJohnson</AgreementName>
<Revision rev=“1.0”></Revision>

</IAInfo>
<NameSpace>

<Id>333333</Id>
<Location ref=“www.intel.com/3”></Location>
<PublicKey>GIE389fjlk8FESfslk32o98743</PublicKey>

</NameSpace>
<NameSpace>

<Id>333334</Id>
<Location ref=“www.intel.com/4”></Location>
<PublicKey>GIE389fj1k8FESfs1k32o98743</PublicKey>

</NameSpace>
<ContractInfo>

<ContractId>777777-1111</ContractId>
<Contract>This is the contract...</Contract>
<ValidityPeriod from=“Jan 1, 1000” to=“Jan 1,

3000”></ValidityPeriod>

<CreationDate>Jan 1, 999</CreationDate>
<LaibleParty>

<ContactName>John Hancock</ContactName>
<SigningPublicKey keyid=“289839283>

tioAFSOf389ffa7f873yf

</SigningPublicKey>

</LiableParty>

</ContractInfo>
<Process Info>

<ProcessDef type=“purchase order”ref=“www.standard.org/1”>
<PerformerRoleMapping>

<FromRole domainId=‘12345’

role=“Purchaser”></FromRole>

<ToRole domainId=‘54321’ role=“Purchase

Agent”></ToRole>

</PerformerRoleMapping>
</ProcessDef>

</ProcessInfo>
<ServiceInfo>
</ServiceInfo>
<Comment>

“This is a comment.”

</Comment>

</InteropAgreement>

Generally, the electronic contract allows the parties to perform the verification tasks of identification, authentication, and authorization of communications between the parties relating to the shared process. The electronic contract of the present invention may be consulted when two types of security decisions are made during communications between two trading partners. The first decision concerns determining if a message (signed by a sender) should be accepted by a receiver based on the sender's company affiliation and the business process or processes shared between the sender's company and the receiver's company. In this case, the electronic contract identifies the companies and their contractual relationship. The sender of the message may then be authenticated as a subordinate of one of the parties in the business relationship (e.g., party A or B). The second decision determines if the sender is authorized to perform the requested action. The electronic contract (as shown in the example of Table I) contains information that allows processors in either trading partner domain to resolve ambiguities in requested actions. Ambiguities can exist in at least the following forms:

(syntax A=syntax B), but (semantic A!=semantic B).

(syntax A!=syntax B), but (semantic A=semantic B).

Evaluation of authorization may be performed by an automated tool because the electronic contract contains the information necessary to perform the mapping. For keys, K(A) authorizes actions performed by A. K(B) authorizes actions performed by B. Role names defined in A map to role names defined in B. Definitions common to both may also be in the electronic contract.

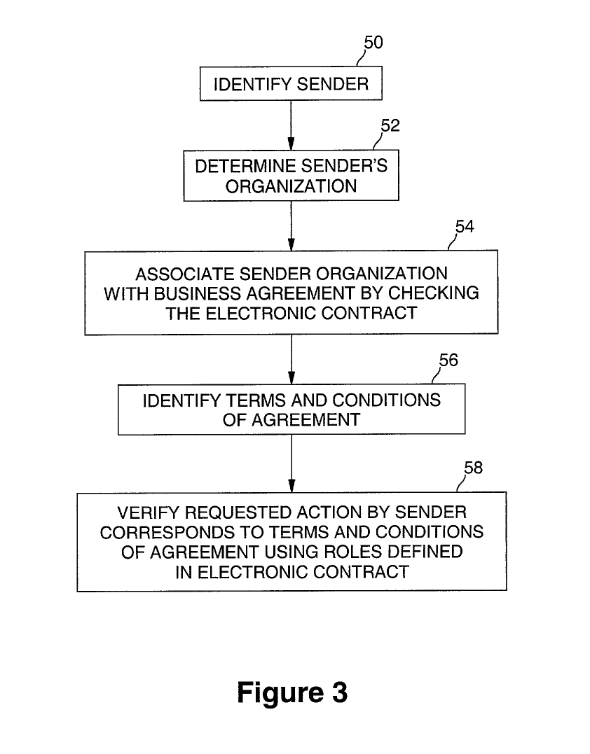

FIG. 3 is a flow diagram of identification and authorization processing using an electronic contract according to an embodiment of the present invention. At block 50, a receiver of a message from a sender identifies the sender. The message from the sender to the receiver may be requesting an action to be performed as part of the process shared between the parties (e.g., the sender's party and the receiver's party). Identification in the present invention may mean merely determining an identifier for the sender. In some embodiments, it may or may not include determining specific identification information for the sender such as name, address, telephone number, e-mail address, taxpayer identification number, and the like. At block 52, the receiver determines the sender's organization (e.g., is the sender a party to the electronic contract?). At block 54, the receiver associates the sender's organization with a business relationship with the receiver's organization as defined by a prior agreement by checking the electronic contract included in the message. This association may be performed without relying on a trusted third party (such as a certificate authority) to provide a common rooted key hierarchy used to implement security of the communication between the two parties.

If A and B relied on a third party C, verification processors in A would know public keys of A and C, but not B. Requestors in B would know about B and C only. When a request is sent to A from B, a certificate from C is needed (indicates C knows B). However, A would not know if the contract A agrees with means the same as the contract B agrees with. Terms and conditions of the agreement are contained in the electronic contract that C may not have represented accurately to B or A. In contrast, with the present invention, if an electronic contract is created between A and B, both parties have the ability to verify the other's signature using a key already known to them, respectfully, A or B's public key.

The receiver at block 56 identifies the terms and conditions of the agreement corresponding to one or more shared processes. At block 58, the receiver verifies that:

the action requested in the message by the sender corresponds to the terms and conditions of the agreement;

the action is allowed by the process (i.e. it is defined); and

the action is allowed for the sender.

This verification may be performed by using roles (e.g., can sender S do requested action X according to the electronic contract?). Digital certificates may be employed in a technique for working through subordinate organizations of the two parties. If a processing system in company A is authorized by A, then A would issue a certificate certifying the processing system. Similarly, a processing system in B may have same relationship with B. If the processing system of A makes a request of the processing system of B, then the processing system of B must determine that the processing system of A is as trustworthy as A with regard to the contract between A & B. If the role or other authorizations assigned to the processing system of A is defined in the contract signed by A & B, then the processing system of B is safe in asserting that the processing system of A is authorized to make the request. The certificate allows processing systems to act on behalf of A and B.

Thus, the creative use of public keys in an electronic contract may be provided such that security of communications may be enforced based on the keys for shared business processes between two parties. Additionally, third party support services may be specified in the electronic contract that may be provided by entities other than the principal parties to the contract in such a way that each of the principal parties may trust the supporting service provider. Although the previous discussion focused on a bilateral arrangement between two parties, embodiments of the present invention may also be used for multi-lateral arrangements between multiple parties for shared processes.

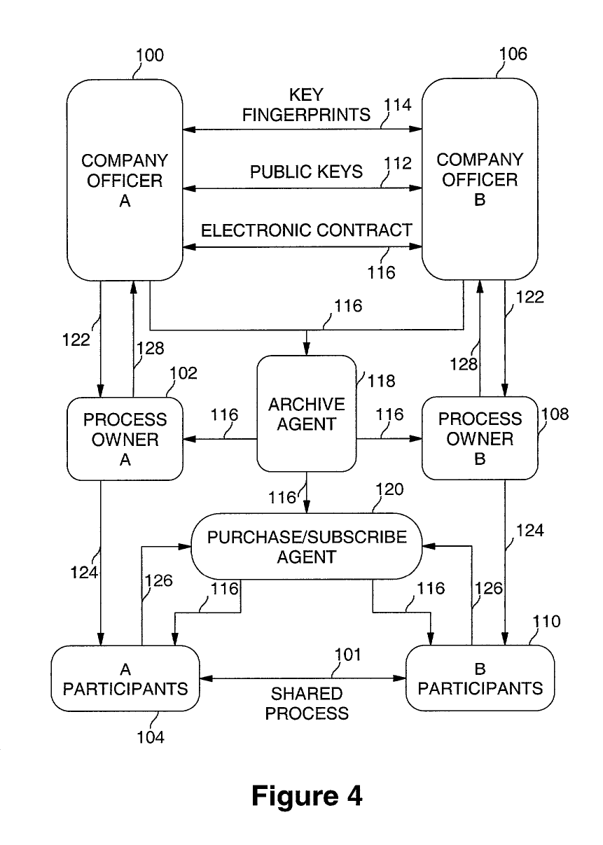

FIG. 4 is a diagram of participants in a shared process 101 and their interactions according to an embodiment of the present invention. Entities of party A 10 are shown on the left side of FIG. 4, such as company officer A 100, process owner A 102, and one or more participants of A 104. Entities of party B 12 are shown on the right side of FIG. 4, such as company officer B 106, process owner B 108, and one or more participants of B 110. Initially, each party wishing to be a trading partner exchanges one or more public keys 112 of asymmetric key pairs with the other party using a reliable out-of-band mechanism. Each party may send one or more public keys to the other party. The exchange may be performed by company officers of the parties (e.g., company officer A 100 and company officer B 106). The reliability of the out-of-band mechanism is such that there is a very low risk that any public key presented to a party was replaced with another key without the knowledge of the presenting party (e.g., via a “man-in-the-middle” attack). In another embodiment, a cryptographic hash of the public key, also called a key fingerprint 114, may be exchanged in place of the public key. In some situations, an exchange of the key fingerprints may be preferable to the exchange of the keys themselves, although the invention is not limited in scope in this respect. The company officers or other legal representatives exchanging keys and/or key fingerprints have the authority to legally commit their organizations and establish business relationships with other entities. Where undeniable proof of authority is lacking, ostensible authority may be determined for a party's representative depending on the circumstances.

It may be unclear whether ostensible authority can be inferred or shown only from electronic interaction. Therefore, it may be preferable that potential trading partners engage in the physical world prior to sharing any automated business processes. Hence, public keys and key fingerprints may be exchanged in person between company officers. There are at least several ways to accomplish the exchange. For example, the company officers may physically exchange business cards, company letterhead, company literature, or other documents, having one or more public keys and/or key fingerprints of the parties.

After the parties negotiate a contract governing their relationship, the company officers digitally sign electronic contract 116 (which defines the shared process 101) using the private keys of the key pairs. A company officer may delegate signing responsibility for the electronic contract to another key, but if he or she does so, he or she must explicitly limit authority under the contract using a role certificate. A role certificate may be an electronic document including a public key and distinguishing information such as a role relevant to the shared process. Role certificates may be presented by participants to the other party to verify, according to the trust rules defined in the electronic contract, that the presenting party is authorized to perform at least a part of the shared process. Role certificates associate a resource (such as a participant) with a shared process element. The role certificate may be signed, thereby binding the key with the information contained therein. Any key used to perform a digital signature of the role certificate must be a key from the electronic contract for the shared process or a delegate of that key (e.g., in the same key hierarchy). The parties must agree on a delegation mechanism as part of the creation of the electronic contract. The delegation mechanism may include issuance of role certificates defining rules for using the keys and managing the shared process.

The electronic contract may be stored by archive agent 118. The archive agent may distribute the electronic contract to the process owners 102, 104, as well as to purchase/subscribe agent 120, who in turn may distribute the electronic contract to participants 104, 110. In one embodiment, the archive agent may be the same entity as the purchase/subscribe agent (that is, their functions may be handled together).

Company officer A 100 then issues one or more authorization certificates 122 to process owner A 102. Similarly, company officer B 106 issues one or more authorization certificates 122 to process owner B 108. Process owners automate the shared process. Authorization certificates inform the process owner of authority to handle elements of a shared process. Role certificates and authorization certificates perform a similar function—describing restrictions on rights/duties of the key holder. Authorization certificates explicitly state the permissions, while role certificates identify a group to which the key holder belongs. A role certificate expects the gatekeeper (e.g., verifier) to know what permissions are appropriate for the role. Authorization certificates include the permissions also. If an authorization certificate is presented, the gatekeeper checks for permissions locally to see if the requested access is allowed according to both of the authorization certificate and the role certificate. Process management includes delegation of authority to perform particular operations relevant to the overall shared business process. This includes partitioning of roles defined by the shared business process and contained in the electronic contract, and delegation of roles to participants via role certificates 124. A process owner may be a person, or any processing system used to perform the process owner function. A process owner may update the process by communicating any change 128 to a company officer, so the change may be incorporated into an updated electronic contract.

Participants may be persons or processing systems (e.g., resources) employed by a party to perform one or more elements or portions of the shared process 101. Participants may also perform the role of enforcing the integrity of the shared process at strategic points occurring anywhere in the process. Participants may register 126 with purchase/subscribe agent 120 to be a part of the process, consistent with their designated role as defined by a role certificate. Participants may use their private keys to secure messages to another party bound to the electronic contract during the shared process.

Thus, embodiments of the present invention provide a system of contracts, roles, delegations, and verifications through which processes may be shared between trading partners. Furthermore, automation strategies may be incorporated into the system without compromising security requirements.

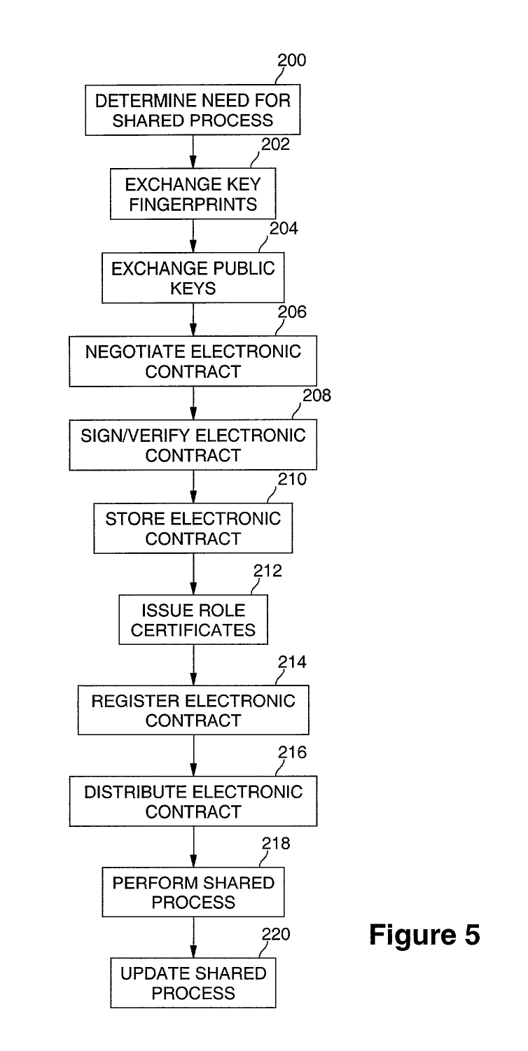

FIG. 5 is a flow diagram illustrating electronic contract lifecycle processing according to an embodiment of the present invention. At block 200, the parties determine the need for a shared process. This may occur formally or informally when corporate officers or other representatives determine that a shared automated business process will be or is needed. According to embodiments of the present invention, either party may initiate the electronic contract lifecycle. If the parties agree that a shared process is needed, then the parties may exchange key fingerprints at block 202 and/or public keys at block 204. Although the examples shown herein detail a process shared between two parties, it is considered to be within the scope of the invention to have any number of parties cooperating in a shared process. Thus, all parties may exchange keys and/or key fingerprints. Each company officer or representative may record which key and/or key fingerprint belongs to which other party. This process may, on some occasions, be as simple as exchanging business cards containing the keys and/or key fingerprints. If the public key of a party is too long to be easily exchanged, the parties may exchange key fingerprints instead of keys. At block 206, the parties negotiate the terms and conditions of the electronic contract governing the shared process, as well define the allowable roles for process elements. In some cases, the electronic contract may completely replace a paper contract.

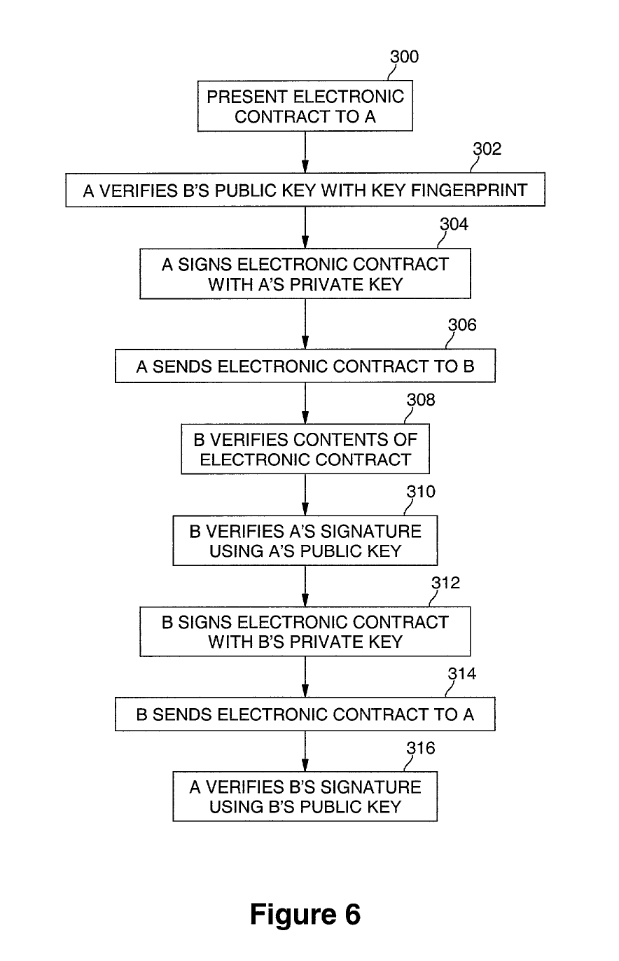

At block 208, the parties sign/verify the electronic contract. FIG. 6 is a flow diagram illustrating the signing and verifying process for an electronic contract according to an embodiment of the present invention. The signing process involves steps to circulate and sign the electronic contract using one of the public keys contained within the electronic contract. The company officer or one of his or her delegates (e.g., process owner or participants) digitally signs the electronic contract for his or her organization. At block 300, the unsigned electronic contract may be presented to a company officer for one of the parties, such as company officer A 100. The electronic contract comprises at least the public key(s) of the trading partners with whom processes are to be shared. At block 302, company officer A 100 uses his or her key fingerprint to verify that B's public key in the electronic contract represents a legitimate relationship between A and B. If the verification passes, at block 304, company officer A signs the electronic contract with A's private key that corresponds to a public key already contained in the electronic contract.

At block 306, company officer A then sends the electronic contract (signed by A) to company officer B 106. At block 308, company officer B verifies the contents of the electronic contract, validating that the contract is consistent with the business relationship and key fingerprints exchanged during contract negotiations. At block 310, company officer B verifies A's signature using A's public key contained in the electronic contract. If the verification passes, then company officer B at block 312 signs the electronic contract with B's private key that corresponds to a public key already contained in the electronic contract. In one embodiment, company officer B only signs the original electronic contract fields and does not sign the signatures that may have been appended to the contract. It may not be important to capture the order in which signatures were applied as part of the contract. The electronic contract also allows for witnesses to notarize the signing of the contract. In this case, the witness may digitally sign the company officer's signature. At block 314, company officer B 106 sends the electronic contract back to company officer A 100. At block 316, the company officer A may use the exchanged keys to verify the signatures on the electronic contract. Hence, company officer A verifies company officer B's signature using company officer B's public key contained in the contract.

When more than two parties are sharing a process, each party must participate in the actions shown in FIG. 6 to ensure that each party is authorized to be a part of the shared process. As a result, the electronic contract contains the signatures of representatives of all parties, indicating that all parties agree to the contract.

Referring again to FIG. 5, once the parties have signed and verified the electronic contract, it may be distributed to the parties. In one embodiment, the electronic contract may be stored by an archive agent 118 at block 210. The archive agent may provide a service to ensure availability of the electronic contract to all interested parties, process owners, and participants. The archive agent may be operated by a third party or jointly by the parties to the electronic contract. The electronic contract itself ensures document integrity in the present invention, hence the archive agent need not provide integrity assurances. The archive agent may provide the electronic contract to the process owners A 102 and B 108. Next, each process owner identifies suitable participants using the electronic contract. For example, process and role names for participants may correspond with process and role names in the electronic contract. The process owner issues a role certificate at block 212 to a participant, thereby enabling the participant to participate securely in shared processes governed by the electronic contract.

Once an electronic contract has been created, it must be made available to participants. Each participant registers with a purchase/subscribe agent 120, in order to be notified in the event of process changes, change of authority (e.g., changes in keys), or security compromises. The participant also at block 214 registers to receive the original electronic contract. The electronic contract may be distributed at block 216 by the purchase/subscribe agent to the registered participants. At block 218, participants implement the shared process.

Participants make access control decisions based on participant credentials relative to the processes for which electronic contracts exist. The participants may also make performance enhancements given an electronic contract. A participant may maintain a cache of electronic contracts that it supports and registers to be notified if an electronic contract is updated. A participant may operate independently until external events require a resetting of the cache. Additionally, participants may pre-compute the validity of electronic contracts and certificates implicated as part of the shared process. The results may be cached by the participant based on computing resources available to the participant. In a resource restricted environment, the participant may rely on a remote agent that performs verification operations and returns results.

At block 220, the shared process may be updated. If the business process changes, then re-signing of the electronic contract may be required. The process owner notifies the company officer, and the company officer determines if the process change invalidates the contract and responds appropriately. The company officer may: 1) renegotiate the business agreement, applying process changes and re-signing the electronic contract; 2) apply process changes and then re-sign the electronic contract; or 3) refuse to apply the process changes. Other events may trigger the need for process changes. If the physical world contract, process validity period or certificate validity period expires, the archive agent and/or the purchase/subscribe agent may need to be notified. If the keys are compromised or security holes are discovered that affect the process, resolution steps may be triggered manually, but propagated automatically to all participants. Termination of the electronic contract may be handled in a manner similar to updating the shared process, with the company officers causing the propagation of an updated electronic contract that halts authorization for the shared process.

The contract lifecycle described herein is symmetric with respect to the parties. Any of the parties may initiate and respond to electronic contract lifecycle events. The present invention reduces security risks over prior art systems by removing a trusted third party, such as a certificate authority, from the system model. With the present invention, authentication is implicit in the relationships set by the parties according to the electronic contract. Since the parties are conjoined principals, the keys of the parties have equivalent authority to manage the shared process.

In the preceding description, various aspects of the present invention have been described. For purposes of explanation, specific numbers, systems and configurations were set forth in order to provide a thorough understanding of the present invention. However, it is apparent to one skilled in the art having the benefit of this disclosure that the present invention may be practiced without the specific details. In other instances, well-known features were omitted or simplified in order not to obscure the present invention.

Embodiments of the present invention may be implemented in hardware or software, or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system using the electronic contract includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a removable storage media or device (e.g., floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

An example of one such type of processing system is shown in FIG. 4, however, other systems may also be used and not all components of the system shown are required for the present invention. Sample system 400 may be used, for example, to execute the processing for embodiments of the method of using the electronic contract, in accordance with the present invention, such as the embodiment described herein. Sample system 400 is representative of processing systems based on the PENTIUM®II, PENTIUM®III, and CELERON™ microprocessors available from Intel Corporation, although other systems (including personal computers (PCs) having other microprocessors, engineering workstations, other set-top boxes, and the like) and architectures may also be used.

FIG. 4 is a block diagram of a system 400 of one embodiment of the present invention. The system 400 includes a processor 402 that processes data signals. Processor 402 may be coupled to a processor bus 404 that transmits data signals between processor 402 and other components in the system 400.

System 400 includes a memory 406. Memory 406 may store instructions and/or data represented by data signals that may be executed by processor 402. The instructions and/or data may comprise code for performing any and/or all of the techniques of the present invention. Memory 406 may also contain additional software and/or data (not shown). A cache memory 408 may reside inside processor 402 that stores data signals stored in memory 406.

A bridge/memory controller 410 may be coupled to the processor bus 404 and memory 406. The bridge/memory controller 410 directs data signals between processor 402, memory 406, and other components in the system 400 and bridges the data signals between processor bus 404, memory 406, and a first input/output (I/O) bus 412. In this embodiment, graphics controller 413 interfaces to a display device (not shown) for displaying images rendered or otherwise processed by the graphics controller 413 to a user.

First I/O bus 412 may comprise a single bus or a combination of multiple buses. First I/O bus 412 provides communication links between components in system 400. A network controller 414 may be coupled to the first I/O bus 412. In some embodiments, a display device controller 416 may be coupled to the first 1/O bus 412. The display device controller 416 allows coupling of a display device to system 400 and acts as an interface between a display device (not shown) and the system. The display device receives data signals from processor 402 through display device controller 416 and displays information contained in the data signals to a user of system 400.

A second I/O bus 420 may comprise a single bus or a combination of multiple buses. The second I/O bus 420 provides communication links between components in system 400. A data storage device 422 may be coupled to the second I/O bus 420. A keyboard interface 424 may be coupled to the second I/O bus 420. A user input interface 425 may be coupled to the second I/O bus 420. The user input interface may be coupled to a user input device, such as a remote control, mouse, joystick, or trackball, for example, to provide input data to the computer system. An audio controller 427 may be coupled to the second I/O bus for handling processing of audio signals through one or more loudspeakers (not shown). A bus bridge 428 couples first I/O bridge 412 to second I/O bridge 420.

Embodiments of the present invention are related to the use of the system 400 for handling electronic contracts. According to one embodiment, such processing may be performed by the system 400 in response to processor 402 executing sequences of instructions in memory 404. Such instructions may be read into memory 404 from another computer-readable medium, such as data storage device 422, or from another source via the network controller 414, for example. Execution of the sequences of instructions causes processor 402 to execute electronic contract processing according to embodiments of the present invention. In an alternative embodiment, hardware circuitry may be used in place of or in combination with software instructions to implement embodiments of the present invention. Thus, the present invention is not limited to any specific combination of hardware circuitry and software.

The elements of system 400 perform their conventional functions in a manner well-known in the art. In particular, data storage device 422 may be used to provide long-term storage for the executable instructions and data structures for handling electronic contracts in accordance with the present invention, whereas memory 406 is used to store on a shorter term basis the executable instructions for handling electronic contracts in accordance with the present invention during execution by processor 402.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. A method of managing a lifecycle of an electronic contract representing a relationship between at least two parties sharing a business process comprising:
exchanging public keys for each of the parties;
negotiating the electronic contract;
digitally signing and verifying the electronic contract;
issuing role certificates to participants of the shared business process, the role certificates defining authorization of participants to perform at least a part of the shared business process and for using the public keys;
registering, by the participants, to receive the electronic contract;
distributing the electronic contract to the participants; and
performing the shared business process by the participants.

2. The method of claim 1, further comprising updating the shared business process by modifying the electronic contract and redistributing the electronic contract to the participants.

3. The method of claim 1, further comprising exchanging key fingerprints between the parties and using the key fingerprints in verifying the electronic contract.

4. The method of claim 1, wherein negotiating the electronic contract comprises determining terms and conditions of the electronic contract and defining allowable roles for participants and process elements.

5. The method of claim 1, further comprising storing the electronic contract by an archive agent prior to distributing the electronic contract and wherein registering to receive the electronic contract comprises registering with a purchase/subscribe agent to receive the electronic contract by the participants.

6. The method of claim 1, wherein the electronic contract is distributed to the participants according to a publish and subscribe model.

7. The method of claim 1, further comprising terminating the electronic contract by modifying the electronic contract to halt authorization of the shared business process.

8. The method of claim 1, wherein digitally signing and verifying the electronic contract comprises cross-checking each other's digital signatures on the electronic contract by the parties, without involving a trusted third party.

9. An article comprising: a storage medium having a plurality of machine readable instructions, wherein when the instructions are executed by a processor, the instructions provide for managing a lifecycle of an electronic contract representing a relationship between at least two parties sharing a business process by exchanging public keys for each of the parties, negotiating the electronic contract, digitally signing and verifying the electronic contract, issuing role certificates to participants of the shared business process, the role certificates defining authorization of participants to perform at least a part of the shared business process and for using the public keys, registering, by the participants, to receive the electronic contract, distributing the electronic contract to the participants, and performing the shared business process by the participants.

10. The article of claim 9, further comprising instructions for updating the shared business process by modifying the electronic contract and redistributing the electronic contract to the participants.

11. The article of claim 9, further comprising exchanging key fingerprints between the parties and using the key fingerprints in verifying the electronic contract.

12. The article of claim 9, wherein negotiating the electronic contract comprises determining terms and conditions of the electronic contract and defining allowable roles for participants and process elements.

13. The article of claim 9, further comprising instructions for storing the electronic contract by an archive agent prior to distributing the electronic contract and wherein instructions for registering to receive the electronic contract comprise instructions for registering with a purchase/subscribe agent to receive the electronic contract by the participants.

14. The article of claim 9, wherein the electronic contract is distributed to the participants according to a publish and subscribe model.

15. The article of claim 9, further comprising instructions for terminating the electronic contract by modifying the electronic contract to halt authorization of the shared business process.

16. The article of claim 9, wherein instructions for digitally signing and verifying the electronic contract comprise instructions for cross-checking each other's digital signatures on the electronic contract by the parties, without involving a trusted third party.

17. A system for managing a lifecycle of an electronic contract comprising:
at least two parties to share a business process represented by the electronic contract, each of parties comprising at least one participant for performing an element of the shared business process, each of the parties exchanging public keys associated with the electronic contract, negotiating the electronic contract, and digitally signing and verifying the electronic contract;
an archive agent coupled to the parties to store the signed and verified electronic contract; and
a purchase/subscribe agent coupled to the archive agent and the parties to receive registrations from the participants and to distribute the signed and verified electronic contract to the participants.

18. The system of claim 17, wherein no dominant authority and no hierarchy of parties exists in the system.

19. The system of claim 17, wherein the at least two parties enforce authorization of participants to perform elements of the shared business process without use of a trusted third party.

20. The system of claim 17, further comprising a role certificate for presentation by a first participant of a first party to a second participant of a second party to verify, according to trust rules defined in the electronic contract, that the first participant is authorized to perform at least part of the shared business process.

21. The system of claim 17, wherein the parties cross-check each other's digital signatures on the electronic contract.

22. The system of claim 17, wherein the parties exchange key fingerprints between the parties.

23. The system of claim 17, wherein the parties determine terms and conditions of the electronic contract and define allowable roles for participants and process elements.
